(19) United States
(12) Patent Application Publication
(10) Pub. No.: US 2018/0267696 A1
(43) Pub. Date: Sep. 20, 2018

(54) LAUNCHING MULTIPLE UNIVERSAL PLATFORM APPLICATION VIEWS THROUGH DESKTOP APPLICATION

(71) Applicant: MICROSOFT TECHNOLOGY LICENSING, LLC, Redmond, WA (US)

(72) Inventor: Kishore Kumar PESHKAR, Redmond, WA (US)

(73) Assignee: MICROSOFT TECHNOLOGY LICENSING, LLC, Redmond, WA (US)

(21) Appl. No.: 15/495,836

(22) Filed: Apr. 24, 2017

Related U.S. Application Data
(60) Provisional application No. 62/471,320, filed on Mar. 14, 2017.

(51) Int. Cl. G06F 3/0484; G06F 3/14; G06F 3/0482; G06F 9/44

(52) U.S. Cl. CPC G06F 3/04845; G06F 9/4443; G06F 3/0482; G06F 3/1454

(57) ABSTRACT

Universal platform applications, while advantageous and efficient, have inherent limitations,, including an. inability to manage multiple views on multiple display devices. According to embodiments,, such management may be facilitated by packaging a universal platform application with a desktop application to launch multiple universal platform application views through the desktop application. The universal platform application may generate a plurality of views in a sequential order for display on a main display device and maintain a task list of the generated views. For each generated view, the universal platform application may transmit a request to the desktop application to move the generated view from the main display device to an available, designated display device and, upon receiving confirmation of the move, transmit another request tor a next generated view to the desktop application based on the task, list. The universal platform application may maintain control of content presented thro ugh the generated views.

### CROSS-REFERENCE TO RELATED APPLICATION

This application claims the benefit under 35 U.S.C. § 119(e) of U.S. Provisional Patent Application No. 62/471,320 filed on Mar. 14,2017. The U.S. Patent Application is herein incorporated by reference in its entirety.

### BACKGROUND

Universal platform applications, which are part of a platform-homogeneous, application architecture, may be executed on a number of operating systems, operating system versions, and/or devices without a need for customization or different versions of the application. Despite advantages and efficiencies of universal platform applications, such programs may also be associated with inherent limitations such, as an inability to manage multiple views on multiple display devices.

Meeting room management applications provide management of meetings in conjunction with ancillary devices, such as displays and audio systems within a meeting space and client devices associated with attendants. Meeting room applications may be provided as universal platform applications, but needs including management of multiple views on multiple display devices may present a challenge in such configurations.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to launching multiple-universal platform application views through a desktop application. An example method according to embodiments may include invoking an application service hosted by the desktop application at a universal platform application, generating two or more views in a sequential order for display on a main display device, and maintaining a task list of the generated views. The example method may also include, for each generated view, transmitting a request to the desktop application, where the request includes information associated with the generated view and an identifier for a designated display device, and transmitting another request for a next generated view to the desktop application upon receiving a confirmation from the desktop application of a move of the generated view to the designated display device. The example method may further include controlling presented content on the generated views.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 includes a display diagram illustrating an example environment for launching multiple universal platform application views through a desktop application;

FIG. 2 includes a display diagram that conceptually illustrates a universal platform application and a desktop application packaged together for launching multiple universal platform application views through the desktop application;

FIG. 3A-3D include display diagrams that conceptually illustrate launching multiple universal platform application views through a desktop application;

FIG. 4 is a networked environment where a system according to embodiments may be implemented;

FIG. 5 is a block diagram of an example communal meeting device, which may be used to execute a universal platform application for launching multiple universal platform application views through a desktop application; and

FIG. 6 includes a logic flow diagram that illustrates a process for launching multiple universal platform application views through a desktop application, according to at least some embodiments disclosed herein.

### DETAILED DESCRIPTION

As briefly described above, embodiments may be provided to launch multiple universal platform application views through a desktop application. According to some examples, a universal platform application may be capable of generating more than one view, but not capable of controlling where the views are to be displayed. A desktop application packaged together with the universal platform application may host an application service for the universal platform application. The universal platform application may invoke the application service hosted by the desktop application. The universal platform application may also generate multiple views in a sequential order for display on a main device and maintain a task list of the generated views based on the sequential order. For each generated view, the universal platform application may transmit a request to the desktop application, the request including information associated with the generated view and an identifier for a designated display device. The universal platform application may transmit another request for a next generated view to the desktop application upon receiving a confirmation from the desktop application of a move of the generated view from the main display device to the designated display device. The universal platform application may control presented content on the generated views displayed on the respective main and designated display devices.

A universal platform application, as used herein, refers to an application that is part of a platform-homogeneous application architecture. Thus, a universal platform application may be executed on a number of operating systems, operating system versions, and/or devices without a need for customization or different versions of the application. For example, the same universal platform application may be installed and executed on a desktop platform and a mobile platform. Some universal platform applications may not indicate having been written for a specific operating system or platform in their manifest build; instead, they may target one or more device families, such as a PC, smartphone, tablet, or gaming system. These extensions may allow the universal platform application to automatically utilize the capabilities that are available to the particular device it is currently naming on. The platform-agnostic nature of these universal, platform applications may allow enhanced user experience aspects in addition to efficiency and reduced complexity. For example, a universal platform application executed on a smartphone may start behaving the way it would, if it were running on a PC when the smartphone is connected to a desktop computer or a suitable docking station. On the other hand, being platform agnostic may mean that some of these universal platforms applications have limitations that the platform-specific applications do not. For example, a number and type of Application Programming Interfaces (APIs) available in a universal platform application may be limited. Thus, a functionality of a universal platform application may also be subject to constraints based on its design such as the ability to launch and manage multiple views on different display devices.

Compared to universal platform applications, desktop applications, as referred to herein, are typically platform-specific such as operating system, operating system version, device, etc. While their specificity may make it more difficult to manage desktop applications on different devices or operating systems, it may also provide them with a higher degree of freedom with respect to functionality. Operating system or device specific APIs may be provided in desktop applications, for example. Thus, desktop applications may lend themselves more toward certain functionality, such as functionality that is associated with monitoring and reacting to events that happen at operating system or hardware level. Following the example provided in the above paragraph, a desktop application may be configured to move multiple universal platform application launched views to designated display devices and adjust their sizes based on a task list maintained by the universal platform application.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction, with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment program modules may be located in both local and remote memory storage devices.

Some embodiments may be implemented as a computer-implemented process (method), a computing system, or as an article of manufacture, such as a computer program, product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can, for example, be implemented via one or more of a volatile computer memory, a non-volatile memory, a hard drive, a Hash drive, a floppy disk, or a compact disk, and comparable hardware media.

Throughout this specification, the term “platform” may be a combination of software and hardware components for executing universal platform applications and desktop applications. Examples of platforms include, but are not limited to, a hosted service-executed, over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

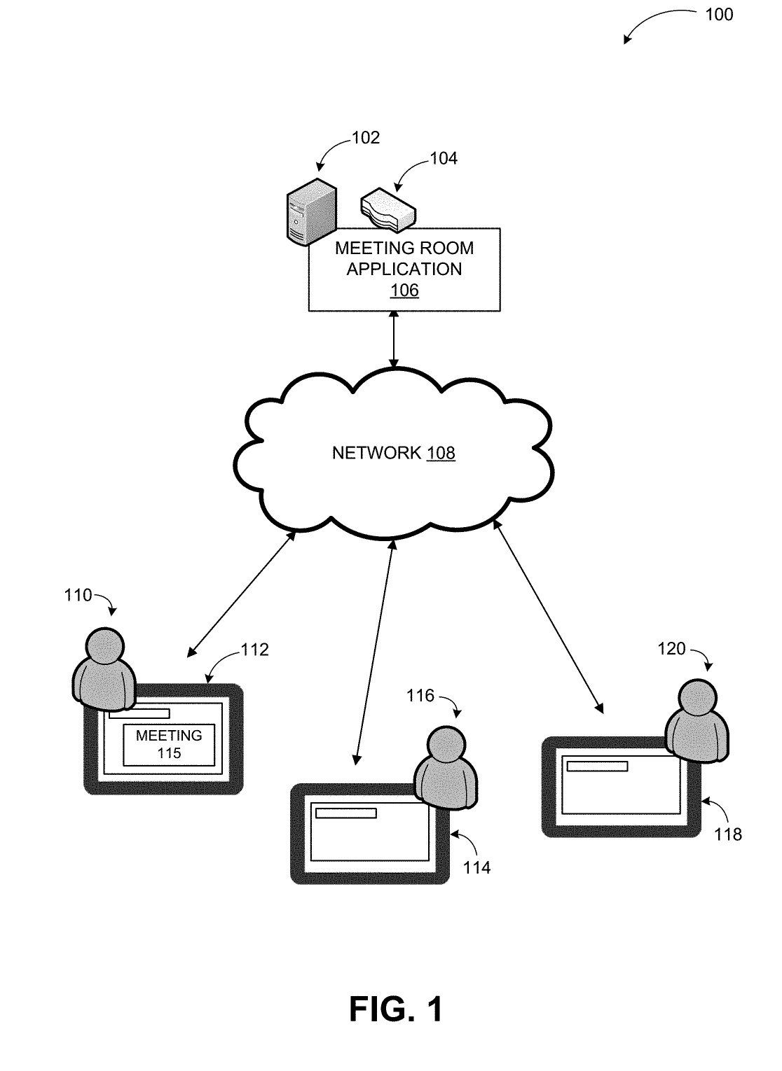

FIG. 1 includes a display diagram illustrating an example environment for launching multiple universal platform application views through a desktop application, according to at least some embodiments disclosed herein.

As illustrated in a diagram 100, an example system may include a meeting room management application 106 executed on a server 102, a communal meeting device 104, or another similar computing device. The communal meeting device 104 may be a special purpose device associated with one or more meeting spaces. The communal meeting device 104 may be configured to manage meetings and ancillary devices, such as display or audio devices in the meeting spaces. In some examples, the meeting room management application 106 may be configured to interoperate with various applications to allow attendants (e.g., attendants 110, 116, and 120) to participate in a meeting 115, provide content to be presented in the meeting 115, control ancillary devices in the meeting space, and perform other meeting related activities. The various applications may be thick (locally installed) or thin (browser) applications executed on client devices 112, 114, and 118, respectively. The interoperation may include exchange of data over one or more networks, such as network 108.

The network 108 may comprise any topology of servers, clients, Internet service providers, and communication media. In some examples, the applications executed on the client devices 112, 114, and 115, respectively, may include productivity applications, such as a presentation application, a word processing application, a communication application, a spreadsheet application, or a meeting application.

As discussed above, a universal platform application may not be capable of launching multiple views to different display devices. Instead, the universal platform application may launch the views to the same display device as the main view associated with the universal platform application. For example, the meeting room management application 106 (a universal platform application) may present a main view on a main display device, the main view comprising general controls associated with a meeting space. Other secondary views may be launched to present meeting content, additional controls, attendant videos, etc, for an initiated or ongoing meeting. A preferred configuration of placing the different main and secondary views on selected display devices in the meeting space (or elsewhere) may not be provided by the limitations of the meeting room management application 106.

According to some embodiments, a universal platform application such as the meeting room management application 106 may be provided as a package with a corresponding desktop application that serves as a hosting service to the universal platform application. The desktop application may be invoked by the universal platform application such that additional secondary views generated by the universal platform application are moved to available display devices and adjusted in size if desired.

As previously discussed, despite advantages and efficiencies of universal platform applications, such programs may also be associated with inherent limitations such as an inability to manage multiple views on multiple display devices. For example, meeting room applications may be provided as universal platform applications, but management of multiple views on multiple display devices may present a challenge in such configurations. According to the above-described embodiments, such management of multiple views on multiple display devices may be facilitated by packaging a universal platform application and a desktop application together to launch multiple universal platform application views through the desktop application. Launching multiple universal platform application views through the desktop application may, among others other things, improve computing device performance, reduce processing and network bandwidth usage associated with a computing device, increase energy savings associated with the computing device, and improve user interaction by allowing users to launch and view multiple views on different displays through the universal platform application.

Embodiments address a need that arises from very large scale of operations created by networked computing and cloud based services that cannot be managed by humans. The actions/operations described herein are not a mere use of a computer, but address results of a system that is a direct consequence of software used as a service, such as management of meetings through universal platform applications.

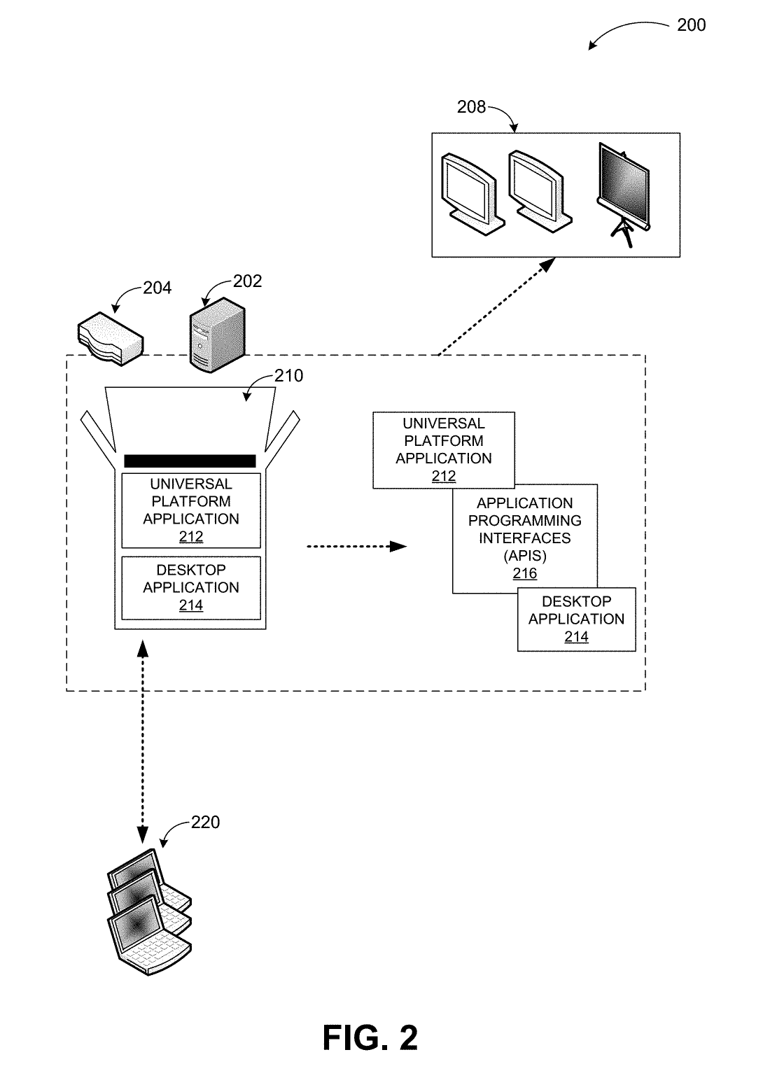

FIG. 2 includes a display diagram that conceptually illustrates a universal platform application and a desktop application packaged together for launching multiple universal platform application views through the desktop application, according to at least some embodiments disclosed herein.

As shown in a diagram 200, a universal platform application 212 may be packaged together with an associated desktop application 214 in an application package 210. In an example embodiment, the application package 210 may be for a meeting room management application executed on a server 202 or communal meeting device 204. The meeting room management application may be configured to facilitate meetings in a meeting space in conjunction with a meeting service, for example. Among other tasks, the meeting room management application may control ancillary devices in the meeting space, allow attendants to connect to the meeting through their client devices, and others. The ancillary devices may include audio components, printers, lighting, and display devices 208. The display devices 208 may include a wall projection system, a screen mounted onto one or more walls within the meeting room, an interactive floor display, an interactive window display, or an interactive wall display, among other examples. Once installed from the application package 210, the universal platform application 212 may include a number of application programming interfaces (APIs) 216 through which it may communicate with the desktop application 214 and other devices/applications (e.g., client devices 220).

In some embodiments, the desktop application 214 may host an application service for the universal platform application 212. During its launch, the universal platform application 212 may initialize the application service and use an application service connection object, such as the APIs 216, to send requests to and receive responses from the desktop application 214. As part of its process, the universal platform application 212 may initially generate a main view and subsequently generate multiple secondary views (e.g., in response to a user action or a state change in processes of the universal platform application 212). The generated main view and secondary views may all be displayed on a main display device (e.g., stacked on the main view, tiled, or in other formats based on a configuration). The universal platform application 212 may maintain a task list of the generated main view and secondary views based on sequential order in which the views are generated.

For each generated secondary view, the universal platform application 212 may invoke the application service at the desktop application 214 and provide information associated with the secondary view (e.g., size of the secondary view) along with a designated display device identifier via the application service connection object.

The desktop application 214 may enumerate available display devices and upon receiving the information associated with the secondary view along with the designated display device identifier from the universal platform application 212, may move the secondary view from the main display device to the designated display device. The universal platform application 212 may then transmit information associated with the next secondary view in the task list to the desktop application 214 until all secondary views are moved and the task list is emptied. The universal platform application 212 may continue controlling the content of the secondary views, as well as when to close the secondary views, on their respective display devices. In some examples, the desktop application 214 may enlarge the secondary views to a full screen or similar mode once they are moved. In other examples, the size of the moved secondary views may be reduced or adjusted to other parameters depending on the designated display devices and/or instructions or request from the universal platform application 212. Upon completion of the move (and optional size adjustment) of the last secondary view in the task list, the desktop application 214 may bring the main view to the foreground on the main display device and enlarge to full screen mode if so desired.

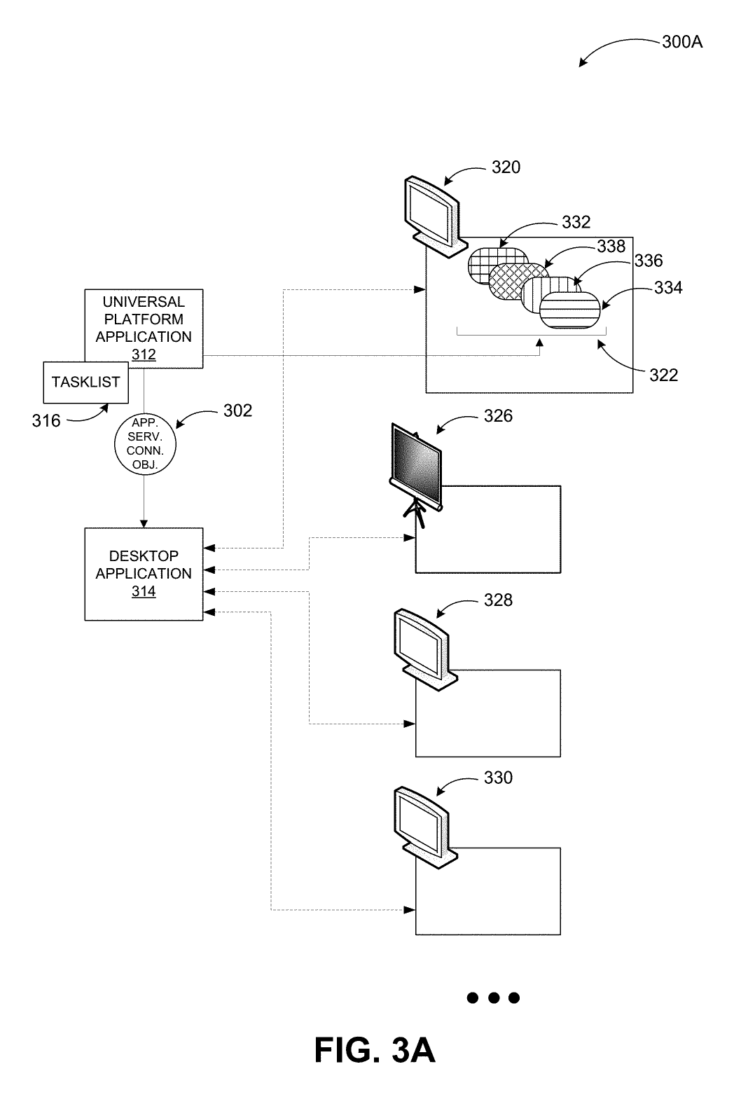

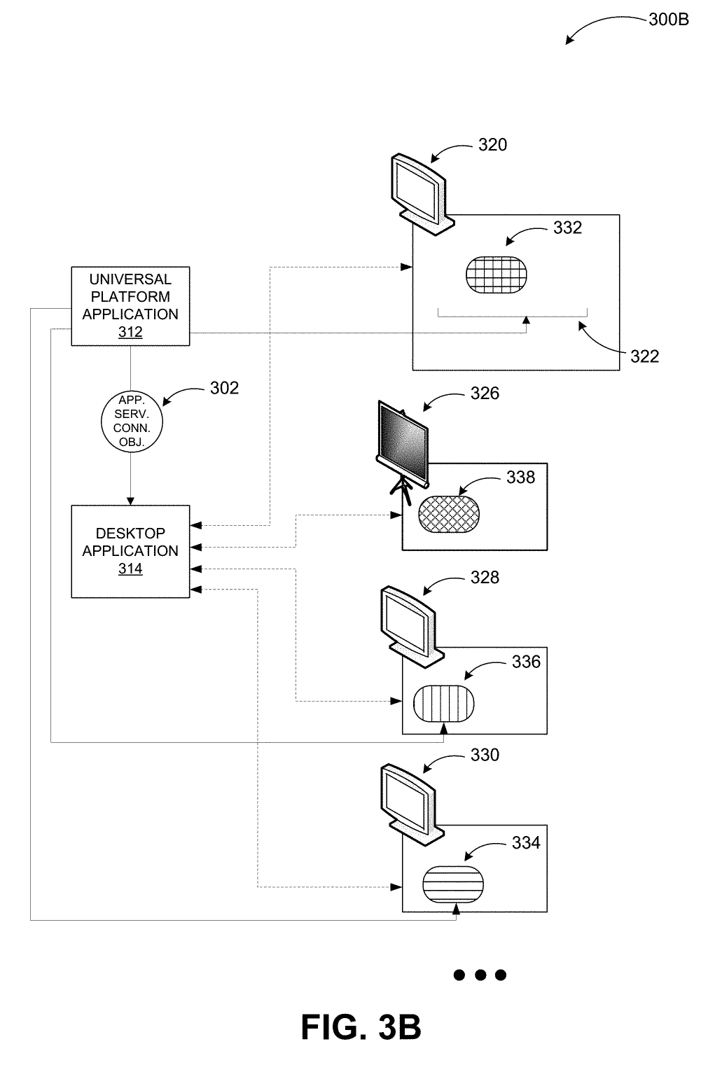

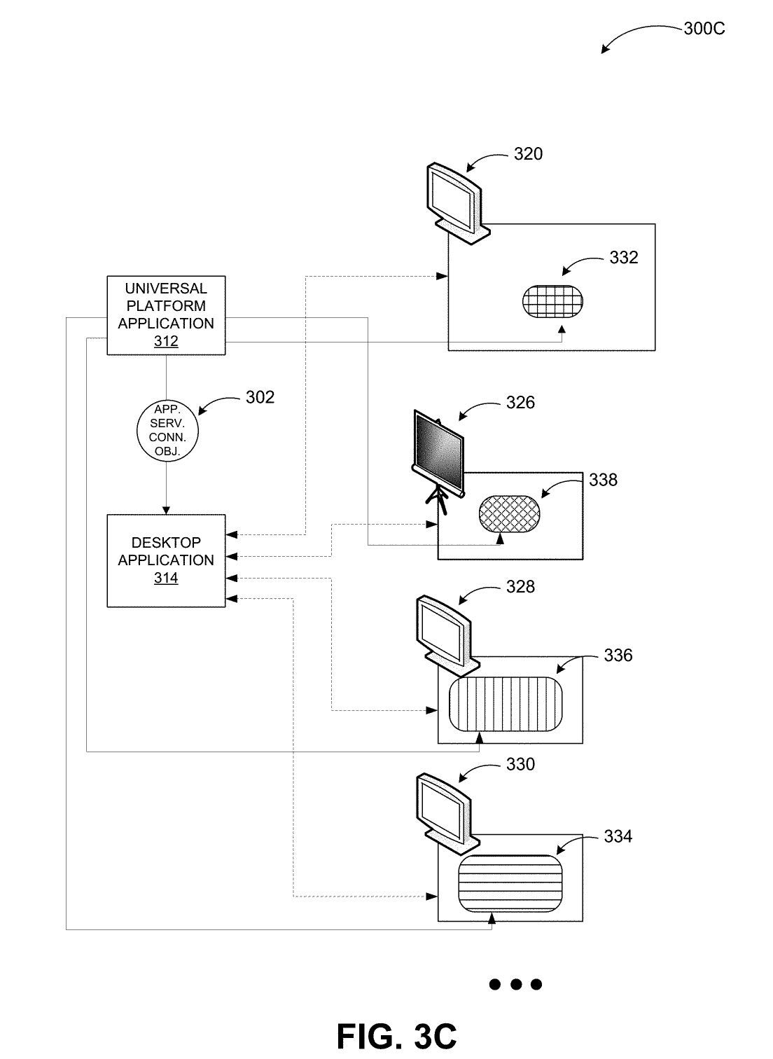

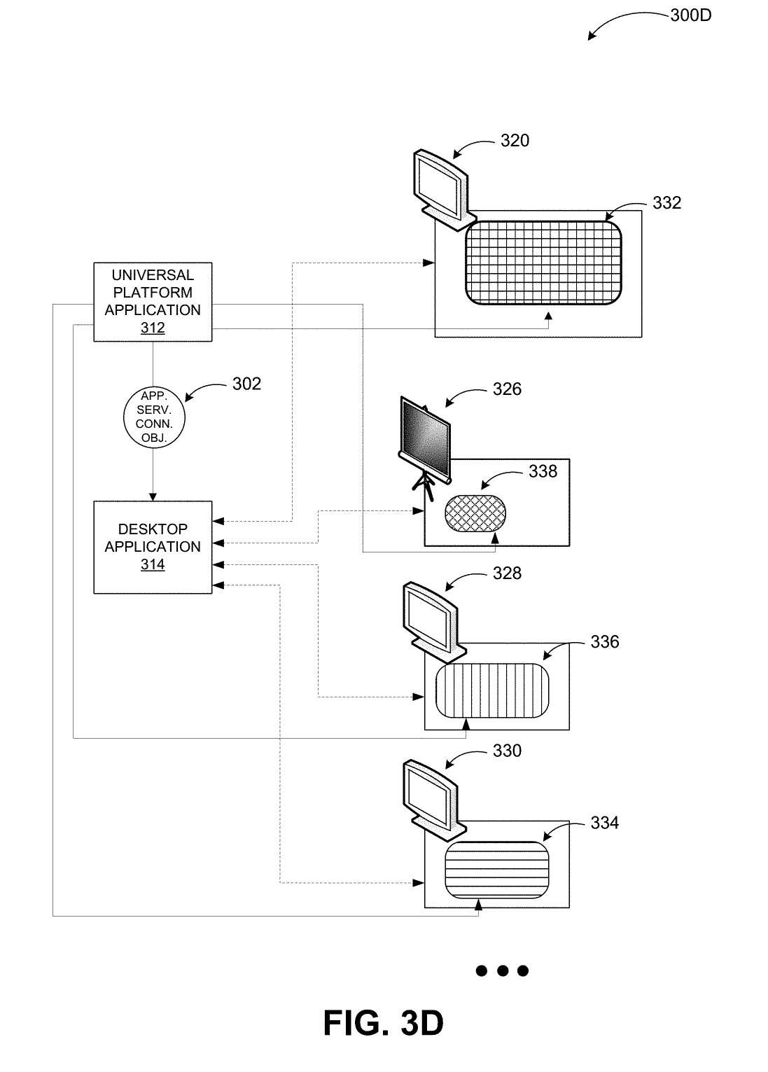

FIGS. 3A-3C include display diagrams that conceptually illustrate launching multiple universal platform application views through a desktop application, according to at least some embodiments disclosed herein.

Diagram 300A of FIG. 3A illustrates launching of multiple views by a universal platform application 312. The universal platform application 312 may launch an initial, main view 332 and a number of subsequent, secondary views 334, 336, 338, collectively referred to as generated views 322, on a main display device 320. The secondary views 334, 336, 338 may be stacked over the main view 332, tiled, or configured otherwise depending on the main display device 320 and/or application configuration. The universal platform application 312 may maintain a task list 316 to store information associated with the generated views 322 and their sequential order. In some examples, the universal platform application 312 may communicate with an associated desktop application 314 via an application service connection object 302 and provide information associated with the generated views 322 (e.g., size of the generated views) and a designated display device identifier for each of the generated views 322. The desktop application 314 may be capable of identifying available display devices (e.g., main display device 320 and potential designated display devices 326, 328, 330).

Diagram 300B of FIG. 3B illustrates a next phase in the example process, where the desktop application 314 may receive the information and the designated display device identifier for each of the secondary views 334, 336, 338 in a sequential order based on the task list, and move the secondary views 334, 336, 338 one-by-one to the designated display devices accordingly. For example, a first secondary view 334 in the task list may be moved to display device 330, then a next secondary view 336 in the task list may be moved to display device 328, and then a last secondary view 338 in the task list may be moved to display device 326.

Diagram 300C of FIG. 3C illustrates a subsequent phase in the example process with optional operations. Upon moving the all of the secondary views 334, 336, 338 according to the order of the task list, the desktop application 314 may enlarge one or more of the secondary views 334, 336, 338 to a full screen mode on respective display devices (e.g., the first secondary view 334 on display device 330 and the next secondary view 336 on display device 328). In other examples, the moved secondary views may be reduced or adjusted to other parameters depending on the designated display device and/or instructions or request from the universal platform application 312.

Diagram 300D of FIG. 3D illustrates a final phase in the example process. Upon moving and optionally enlarging, reducing, or otherwise adjusting all of the secondary views 334, 336, 338 from the main display de vice 320 according to the order of the task list, the desktop application 314 may bring the main view 332 to the foreground on the main display device 320 and optionally enlarge the main view 332 to a foil screen mode, as illustrated.

A textual scheme, a graphical scheme, an audio scheme, an animation scheme, a coloring scheme, a highlighting scheme, and/or a shading scheme may be employed to further enhance user interaction with a client interface of the universal platform application 312 for launching multiple universal platform application views through the desktop application 314.

The examples provided in FIG. 1 through FIG. 3C are illustrated with specific systems, services, applications, views, and display devices. Embodiments are not limited to environments according to these examples. Embodiments for launching multiple universal platform application views through a desktop application may be implemented in environments employing fewer or additional systems, services, applications, views, and display devices. Furthermore, the example systems, services, applications, views, and display devices shown in FIG. 1 through FIG. 3C may be implemented in a similar manner with other values using the principles described herein.

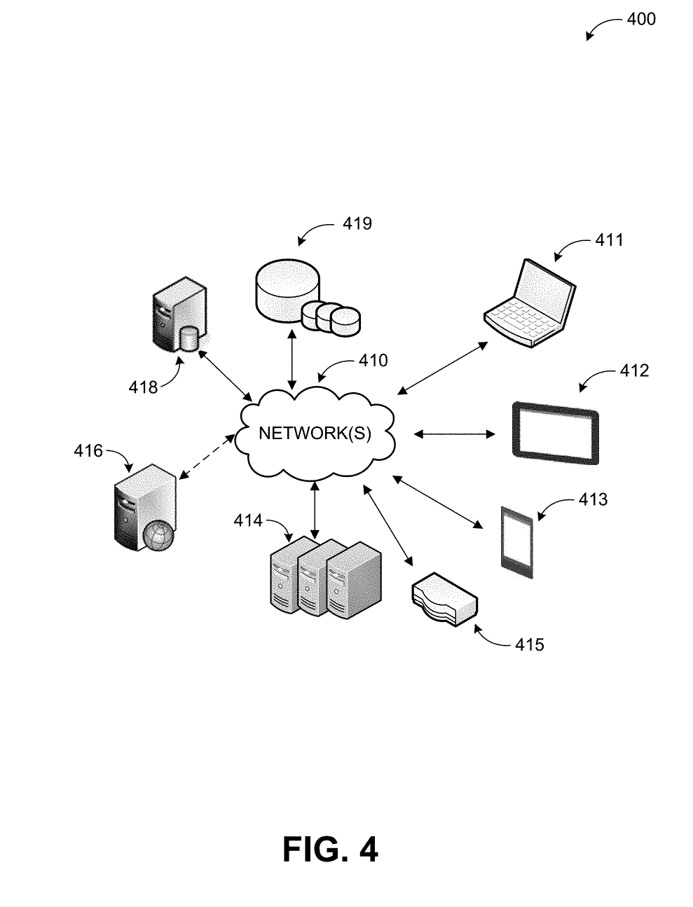

FIG. 4 is a networked environment, where a system according to embodiments may be implemented.

As shown in a diagram 400, a universal platform service may be implemented in a networked environment over one or more networks, such as a network 410. Participants may access the universal platform service through locally installed client applications or thin (e.g., browser-based) client applications executed on a variety of computing/client devices (e.g., a laptop 411, a tablet 412, and/or a smartphone 413, etc.). Functionality within the universal platform service may be provided by one or more universal platform applications executed on servers 414, special purpose device 415, or processing server 416. The universal platform service may store data associated with a meeting in a data store 419 directly or through a database server 418.

The network 410 may comprise any topology of servers, clients, Internet service providers, and communication media. A system according to embodiments may have a static or dynamic topology. The network 410 may include multiple secure networks, such as an enterprise network, an unsecure network, or the Internet. The unsecure network may include a wireless open network. The network 410 may also coordinate communication over other networks, such as Public Switched Telephone Network (PSTN) or cellular networks. Furthermore, the network 410 may include multiple short-range wireless networks, such as Bluetooth, or similar ones. The network 410 may provide communication between the nodes described herein. By way of example, and not limitation, the network 410 may include wireless media. The wireless media may include, among others, acoustic media, RF media, infrared media, and other wireless media.

Many other configurations of computing devices, applications, engines, modules, data sources, and data distribution systems maybe employed for launching multiple universal platform application views through desktop application. Furthermore, the networked environments discussed in FIG. 4 are for illustration purposes only. Embodiments are not limited to the example applications, modules, engines, or processes.

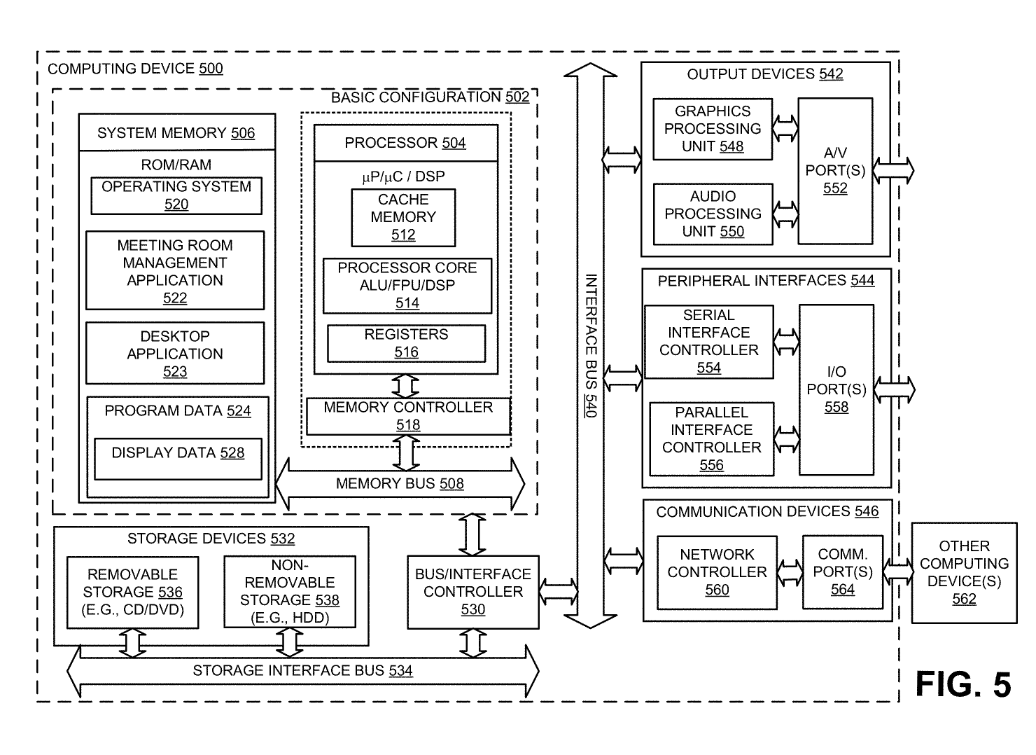

FIG. 5 is a block diagram of an example communal meeting device, which may be used to launch multiple universal platform application views through a desktop application, according to at least some embodiments described herein.

For example, a computing device 500 (e.g., a communal meeting device) may be a special purpose device composed of generic and special purpose hardware and software components or a special purpose component integrated into a general purpose computing device. In an example basic configuration 502, the computing device 500 may include one or more processors 504 and a system memory 506. A memory bus 508 may be used for communicating between the processor 504 and the system memory 506. The example basic configuration 502 is illustrated in FIG. 5 by those components within the inner dashed line.

Depending on the desired configuration, the processor 504 may be of any type, including but not limited to a microprocessor (μP), microcontroller (μC), a digital signal processor (DSP), or any combination thereof. The processor 504 may include one more levels of caching, such as a level cache memory 512, one or more processor cores 514, and registers 516. The one or more processor cores 514 may (each) include an arithmetic logic unit (ALU), a floating point unit (FPU), a digital signal processing core (DSP Core), or any combination thereof. An example memory controller 518 may also be used with the processor 504, or in some implementations the example memory controller 518 may be an internal part of the processor 504.

Depending on the desired configuration, the system memory 506 may be of any type including but not limited to volatile memory (such as RAM) and non-volatile memory (such as ROM, flash memory, etc.), or any combination thereof The system memory 506 may include an operating system 520, a meeting room management application 522, a desktop application 523, and program data 524. The meeting room management application 522 may be a universal platform application that in conjunction with the associated desktop application 523 may be configured to launch multiple universal platform application views through the desktop application 523. For example, the desktop application 523 may be included in an application package together with the meeting room management application 522. The program data 524 may include display data 528 (e.g., display characteristics associated with available displays).

The computing device 500 may have additional features or functionality, and additional interfaces to facilitate communications between the example basic configuration 502 and any desired devices and interfaces. For example, a bus/interface controller 530 may be used to facilitate communications between the example basic configuration 502 and one or more data storage devices 532 via a storage interface bus 534. The data storage devices 532 may be one or more removable storage devices 536, one or more non-removable storage devices 538, or a combination thereof. Examples of the removable storage and the non-removable storage devices include magnetic disk devices such as flexible disk drives and bard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 506, the removable, storage devices 536 and the non-removable storage devices 538 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 540 for facilitating communication from various interface devices (for example, one or more output devices 542, one or more peripheral interfaces 544, and an example communication device 546) to the example basic configuration 502 via the bus/interface controller 530. Some of the one or more output devices 542 may include a graphics processing unit 548 and an audio processing unit 550, which may be configured to communicate with various external devices, such as a display or speakers via one or more A/V ports 552. The one or more peripheral interfaces 544 may include a serial interface controller 554 or a parallel interface controller 556, which may be configured to communicate with external devices, such as input devices (e.g., a keyboard, a mouse, a pen, a voice input device, and/or a touch input device, etc.) or other peripheral devices (e.g., a printer and/or a scanner, etc.) via one or more I/O ports 558. The example communication device 546 may include a network controller 560, which may be arranged to facilitate communications with one or more other computing devices 562 over a network communication link via one or more communication ports 564. The one or more other computing devices 562 may include servers, computing devices, and comparable devices.

The network communication link may be one example of a communication media. The communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, the communication media may include wired media such as a wired network or direct-wired connection, and wireless media such as acoustic, radio frequency (RF), microwave, infrared (IR) and other wireless media. The term computer readable media, as used herein, may include both storage media and communication media.

Example embodiments may also include methods for launching multiple universal platform application views through a desktop application. These methods can be implemented in any number of ways, including the structures described herein. One such way may be by machine operations of devices of the type described in the present disclosure. Another optional way may be for one or more of the individual operations of the methods to be performed in conjunction with one or more human operators performing some of the operations while other operations may be performed by machines. These human operators need not be co-located with each other, but each can be only with a machine that performs a portion of the program. In other embodiments, the human Interaction can be automated such as by pre-selected criteria that may be machine automated.

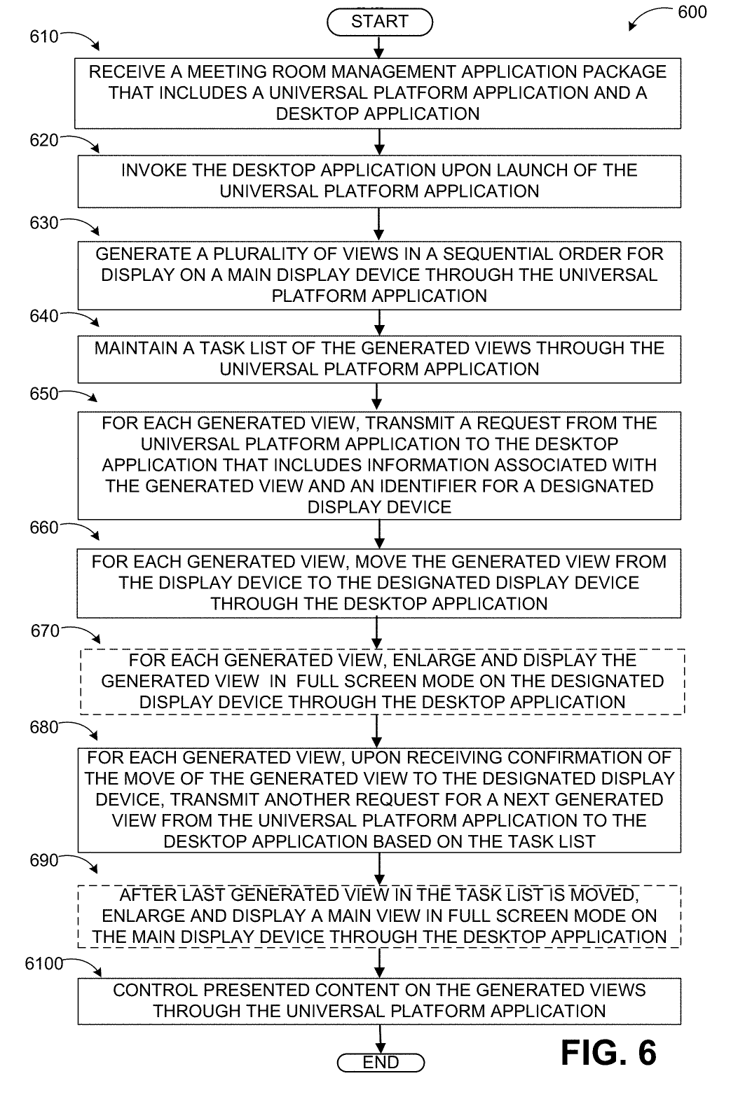

FIG. 6 includes a logic flow diagram that illustrates a process for launching multiple universal platform application views through a desktop application, according to at least some embodiments disclosed herein.

Process 600 may be implemented on a computing device, a server, or another system, such as a communal meeting device. An example computing device may include a communication interface, one or more sensors, a memory, and a processor. The communication interlace may be configured to facilitate an exchange of data with other computing devices. The one or more sensors may be configured to detect an activity within a meeting room. The memory may be configured to store instructions. The processor may be coupled to the communication interface, the one or more sensors, display devices, and/or the memory, among other components.

Process 600 begins with operation 610, where the processor may be configured to receive a meeting room management application package that includes a universal platform application and the desktop application. At operation 620, the desktop application may be invoked upon launch of the universal platform application. Alternatively, the desktop application may be invoked each time a view is generated and maintained by the universal platform application. The universal platform application may communicate with the desktop application through an application service connection object for the purposes of launching and managing generated views.

At operation 630, the universal platform application may be configured to generate a plurality of views in a sequential order for display on a main display device. The generated views may include a main view and at least two or more secondary views. At operation 640, the universal platform application may be configured to maintain a task list for the generated views. For example, the task list may keep track of a first generated, secondary view, a next generated secondary view, etc., up to a last generated secondary view.

At operation 650, for each generated view, a request may be transmitted from the universal platform application to She desktop application that includes information associated with the generated view and an identifier for a designated display device. The information associated with the generated view may include a size of the generated view and an instruction to adjust the size of the generated view upon the move of the generated view to the designated display device. The instruction to adjust the size of the generated view may be to enlarge the size of the generated view to a full screen mode, reduce the size of the generated view, or adjust the size of the generated view based on a parameter of the designated display device.

At operation 660, for each generated view, the desktop application may be configured to move the generated view from the main display device to the designated display device. Optionally, at operation 670, the desktop application may be configured to enlarge and display the generated view in a full screen mode on the designated display device. Alternatively, a size of the generated view may be reduced or otherwise adjusted based on a parameter of the designated display device.

At operation 680, upon receiving a confirmation from the desktop application of the move (and optional enlargement) of the generated view to the designated display device, another request may be transmitted for a next generated view from the universal platform application to the desktop application. The other request may include information associated with the next generated view and an identifier for a designated display device. For example, if confirmation of a first generated secondary view's move from a laptop computer to a projector device is received, the universal platform application may be configured to transmit another request for a second generated secondary view (the next generated view in the task list) to the desktop application. Optionally, at operation 690, the main view may be enlarged and displayed in a full screen mode on the main display device after a last secondary view in the task list is moved through the desktop application. For example, if confirmation of a move of a last generated secondary view in the task list from the laptop computer to a television monitor is received, the main view may be brought forward to a foreground on the laptop.

At operation 6100, the universal platform application may be configured to control content that is being presenting on the generated views being displayed on respective designated display devices.

The operations included in process 600 are for illustration purposes. Launching of a universal platform application secondary view on a designated display may be implemented by similar processes with fewer or additional steps, as well as in a different order of operations using the principles described herein. The operations described herein may be executed by one or more processors operated on one or more computing devices, one or more processor cores, specialized processing devices, and/or general purpose processors, among other examples.

According to some embodiments, a means to launch multiple universal platform application views through a desktop application is provided. Example means may include, at a universal platform application, invoking an application service hosted by the desktop application, generating a plurality of views in a sequential order for display on a main display device, and maintaining a task list of the generated views. The example means may also include, for each generated view: transmitting a request to the desktop application, where the request may include information associated with the generated view and an identifier for a designated display device, upon receiving a confirmation from the desktop application of a move of the generated view from the main display device to the designated display device, transmitting another request for a next generated view to the desktop application based on the task list, and controlling presented content on the generated views.

According to some examples, methods executed on computing devices are provided for launching multiple universal platform application views through a desktop application. An example method may include, at a universal platform application, invoking an application service hosted by the desktop application, generating a plurality of views in a sequential order for display on a main display device, and maintaining a task list of the generated views. The example method may also include, for each generated view: transmitting a request to the desktop application, where the request may include information associated with the generated view and an identifier for a designated display device, upon receiving a confirmation from the desktop application of a move of the generated vie w from the main display device to the designated display device, transmitting another request for a next generated view to the desktop application based on the task list, and controlling presented content on the generated views.

In other examples, for each generated view, the request may be transmitted to the desktop application upon receiving confirmation from the desktop application of a move of a preceding generated view in the task list to a designated display device. For each generated view, the request may be transmitted to the desktop application upon receiving confirmation from the desktop application of a move of a preceding generated view in the task list to a designated display device and an adjustment of a size of the preceding generated view on the designated display device by the desktop application. The adjustment of the size of the preceding generated view may include to enlarge the size of the preceding generated view to a full screen mode, reduce the size of the preceding genera ted view, or adjust the size of the preceding generated view based on a parameter of the designated display device.

In further examples, a main view and at least two or more secondary views may be generated in a sequential order. Upon receiving confirmation from the desktop application of a move of a last generated secondary view in the task list to a designated display device, the main view may be brought to the foreground on the main display device. The main view may also be enlarged to a full screen mode on the main display device.

In yet further examples, the application service may be invoked upon launch of the universal platform application or upon the universal platform application generating each view. The request may be transmitted to and the confirmation received from the desktop application via an application service connection object stored by the universal platform application. The universal platform application and the desktop application may be packaged together prior to installation of the universal platform application on the computing device.

According to some embodiments, computing devices configured to launch multiple universal platform application views through a desktop application are described. An example computing device includes a communication interface configured to facilitate exchange of data with other computing devices and display devices, a memory configured to store instructions, and a processor coupled to the communication interface, the display devices, and the memory. The processor may be configured to execute a universal platform application packaged together with the desktop application prior to installation of the universal platform application. The desktop application may be configured to identify available display devices. The universal platform application may be configured to invoke an application service hosted by the desktop application, generate a plurality of views in a sequential order for display on a main display device, and maintain a task list of the generated views. For each generated view, universal platform application may also be configured to transmit a request to the desktop application, wherein the request includes information associated with the generated view and an identifier for a designated display device, upon receiving a confirmation from the desk top application of a move of the generated view from the main display device to the designated display device, transmit another request for a next generated view to the desktop application based on the task list, and control presented content on the generated views.

In other embodiments, the information associated with the generated view may include a size of the generated view and an instruction to adjust the size of the generated view upon the move of the generated view to the designated display device. The instruction to adjust the size of the generated view may include to enlarge the size of the generated view to a full screen mode, reduce the size of the generated view, or adjust the size of the generated view based on a parameter of the designated display device.

In further embodiments, the other request for the next generated view transmitted to the desktop application may include information associated with the next generated view and an identifier for a designated display device. The designated display device may be one of the available display devices identified by the desktop application.

In some examples, communal devices configured to launch multiple universal platform application views through a desktop application are described. An example communal device may include a communication interface configured to facilitate exchange of data with computing devices and ancillary devices in a meeting space, a memory configured to store instructions, and a processor coupled to the communication interface, the ancillary devices, and the memory. The processor may be configured to receive a meeting room management application, package that includes a universal platform application and the desktop application, invoke the desktop application upon launch of the universal platform application, generate a plurality of views in a sequential order for display on a main display device through the universal platform application, and maintain a task list of the generated views through the universal platform application. For each generated view, the processor may also be configured to transmit a request from the universal platform application to the desktop application, where the request includes information associated with the generated view and an identifier for a designated display device, move the generated view from the main display device to the designated display device through the desktop application, and upon receiving a confirmation from the desktop application of the move of the generated view to the designated display device, transmit another request for a next generated view to the desktop application. The processor may further be configured to control presented content on the generated views through the universal platform application.

In other examples, the generated views may include a main view and at least two or more secondary views, and generation of each of the secondary views may be in response to a user action or a state change in processes of the universal platform application. The meeting room management application package may be configured to interoperate with other applications to enable users to participate in a meeting, provide content to be presented in the meeting, control the ancillary devices in the meeting space, and perform other meeting related activities. The universal platform application may comprise one or more application programming interfaces (APIs) through which the universal platform application communicates with the desktop application and the other applications.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device for launching multiple universal platform application views through a desktop application, the method comprising:
at a universal platform application, invoking an application service hosted by the desktop application;
generating a plurality of views in a sequential order for display on a main display device;
maintaining a task list of the generated views;
for each generated view:
transmitting a request to the desktop application, wherein the request includes information associated with the generated view and an identifier for a designated display device;
upon receiving a confirmation from the desktop application of a move of the generated view from the main display device to the designated display device, transmitting another request for a next generated view to the desktop application based on the task list; and
controlling presented content on the generated views.

2. The method of claim 1, further comprising:
for each generated view, transmitting the request to the desktop application upon receiving confirmation from the desktop application of a move of a preceding generated view in the task list to a designated display device.

3. The method of claim 1, further comprising:
for each generated view, transmitting the request to the desktop application upon receiving confirmation from the desktop application of a move of a preceding generated view in the task list to a designated display device and an adjustment of a size of the preceding generated view on the designated display device by the desktop application.

4. The method of claim 3, wherein the adjustment of the size of the preceding generated view includes to one of: enlarge the size of the preceding generated view to a foil screen mode, reduce the size of the preceding generated view, and adjust the size of the preceding generated view based on a parameter of the designated display device.

5. The method of claim 1, wherein generating a plurality of views in a sequential order comprises:
generating a main view and at least two or more secondary views in a sequential order.

6. The method of claim 5, further comprising:
upon receiving confirmation from the desktop application of a move of a last generated secondary view in the task list to a designated display device, bringing the main view to foreground on the main display device.

7. The method of claim 6, further comprising:
enlarging the main view to a full screen mode on the main display device.

8. The method of claim 1, wherein invoking the application service hosted by the desktop application comprises:
invoking the application service upon launch of the universal platform application.

9. The method of claim 1, wherein invoking the application service hosted by the desktop application comprises:
invoking the application service upon the universal platform application generating each view.

10. The method of claim 1, further comprising:
transmitting the request to and receiving the confirmation from the desktop application via an application service connection object stored by the universal platform application.

11. The method of claim 1, wherein tire universal platform application and the desktop application are packaged together prior to installation of the universal platform application on the computing device.

12. A computing device configured to launch multiple universal platform application views through a desktop application, the computing device comprising:
a communication interface configured to facilitate exchange of data with other computing devices and display devices;
a memory configured to store instructions; and
a processor coupled to the communication interface, the display devices, and the memory, wherein the processor is configured to execute:
a universal platform application packaged together with the desktop application prior to installation of the universal platform application, wherein
the desktop application is configured to identify available display devices; and
the universal platform application is configured to:
invoke an application service hosted by the desktop application;
generate a plurality of views in a sequential order for display on a main display device;
maintain a task list of the generated views; for each generated view:
transmit a request to the desktop application, wherein the request includes information associated with the generated view and an identifier for a designated display device;
upon receiving a confirmation from the desktop application of a move of the generated view from the main display device to the designated display device, transmit another request for a next generated view to the desktop application based on the task list; and
control presented content on the generated views.

13. The computing device of claim 12, wherein the information associated with the generated view includes a size of the generated view and an instruction to adjust the size of the generated view upon the move of the generated view to the designated display device.

14. The computing device of claim 13, wherein the instruction to adjust the size of the generated view includes to one of: enlarge the size of the generated view to a fell screen mode, reduce the size of the generated view, and adjust the size of the generated view based on a parameter of the designated display device.

15. The computing device of claim 12, wherein the other request for the next generated view transmitted to the desktop application includes information associated with the next generated view and an identifier for a designated display device.

16. The computing device of claim 12, wherein the designated display device is one of the available display devices identified by the desktop application.

17. A communal device configured to launch multiple universal platform implication views through a desktop application, the communal device comprising:
a communication interface configured to facilitate exchange of data with computing devices and ancillary devices in a meeting space;
a memory configured to store instructions; and
a processor coupled to the communication interface, the ancillary devices, and the memory, wherein the processor is configured to:
receive a meeting room management application package that includes a universal platform application and the desktop application;
invoke the desktop application upon launch of the universal platform application;
generate a plurality of views in a sequential order for display on a main display device through the universal platform application;
maintain a task list of the generated views through the universal platform application;
for each generated view:
transmit a request from the universal platform application to the desktop application, wherein the request includes information associated with the generated view and an identifier for a designated display device;
move the generated view from the main display device to the designated display device through the desktop application; and
upon receiving a confirmation from the desktop application of the move of the generated view to the designated display device, transmit another request for a next generated view to the desktop application; and
control presented content on the generated views through the universal platform application.

18. The communal device of claim 18, wherein the generated views include a main view and at least two or more secondary views, and generation of each of the secondary views is in response to a user action or a state change in processes of the universal platform application.

19. The communal device of claim 18, wherein the meeting room management application package is configured to interoperate with other applications to enable users to participate in a meeting, provide content to be presented in the meeting, control the ancillary devices in the meeting space, and perform other meeting related activities.

20. The communal device of claim 19, wherein the universal platform application comprises one or more application programming interfaces (APIs) through which the universal platform application communicates with the desktop application and the other applications.
